(19) United States
(12) Patent Application Publication
(10) Pub. No.: US 2009/0046799 A1
(43) Pub. Date: Feb. 19, 2009

(54) DECODER AND DECODING METHOD SUPPORTING OFDM/OFDMA

(75) Inventors: Zheng Zi Li, Gyeonggi (KR); Yong Suk Hwang, Gyeonggi (KR); Jae Hyeong Kim, Seoul (KR)

Correspondence Address: BLANK ROME LLP, 600 NEW HAMPSHIRE AVENUE, N.W., WASHINGTON, DC, 20037, US

(73) Assignee: POSTDATA CO., LTD

(21) Appl. No.: 12/162,643

(22) PCT Filed: Feb. 21, 2007
(86) PCT No.: PCT/KR2007/000897

§ 371 Date: Jul. 30, 2008

(30) Foreign Application Priority Data
Feb. 21, 2006 (KR) 10-2006-0016803

(51) Int. Cl. H04L 27/28; H04L 27/22

(52) U.S. Cl. 375/267; 375/341; 375/329

(57) ABSTRACT

Provided are an apparatus and method for efficiently decoding signals input through a plurality of antennas in a system supporting an Orthogonal Frequency Division Multiplexing (OFDM)/Orthogonal Frequency Division Multiple Access (OFDMA) scheme. A method for decoding signals received via at least two paths through a plurality of antennas in a system supporting an 0FDM/0FDMA scheme, the method comprising the steps of: measuring power of a signal received via each path; generating correlation metrics by calculating inner products of basis vector sets or multiplying the basis vector sets in units of tiles or bins of the signal; generating decoding metrics based on the measured power of each path and the correlation metrics; and determining a payload on the basis of the decoding metrics. An apparatus for decoding signals received via at least two paths through a plurality of antennas in a system supporting an OFDM/OFDMA scheme, the apparatus comprising: a signal power measuring means for measuring power of a signal received via each path; a demodulation/decoding means for generating correlation metrics corresponding to likelihood of potential payload values of a signal received via each path; and a maximum ratio combining (MRC)/determination means for determining a payload based on the measured power of each path and the correlation metrics.

### TECHNICAL FIELD

The present invention relates to an apparatus and method for effectively decoding signals input through a plurality of antennas in a wireless communication system, and more particularly, to an apparatus and method for decoding a control signal transmitted on an uplink frame in a radio access station (RAS) having an overlapping sector in an Orthogonal Frequency Division Multiplexing (OFDM)/Orthogonal Frequency Division Multiple Access (OFDMA) communication system.

### BACKGROUND ART

Wireless communication systems, that are either currently or expected to be commercialized, have radio access stations (RASs) performing wireless data communication with portable subscriber stations (PSSs). In order to manage a two-dimensional area in which one RAS is centered, 3 antennas are theoretically needed, but an antenna having an overlapping radiation area and an overlapping usable frequency may be additionally installed to increase traffic processing capability. When an antenna is additionally installed as described above, or a PSS exists at the boundary of a sector assigned to an antenna, a signal for one PSS may be simultaneously perceived by two or more antennas installed on one RAS.

In this case, according to conventional art, the RAS determines an antenna that a higher power is detected and performs communication through the determined antenna. The conventional art processes a signal received through only one antenna and thus causes problems for the RAS, such as efficiency deterioration, (e.g., increase in amplification degree, etc.) and receiving-quality deterioration caused when noise is injected not into other antennas but into the determined antenna only.

In addition, the conventional art may cause a PSS to increase its output power and thus has a problem of reducing the usable time of the PSS.

### DISCLOSURE

### Technical Problem

The present invention is directed to a decoding method and apparatus capable of increasing power consumption efficiency in a radio access station (RAS) having a plurality of antennas.

In further detail, the present invention is directed to a decoding method and apparatus using signals received through a plurality of antennas.

The present invention is also directed to a decoding method and apparatus capable of improving the receiving signal quality of an RAS having a plurality of antennas.

The present invention is also directed to a decoding method and apparatus capable of increasing the power consumption efficiency of a connected PSS in an RAS having a plurality of antennas.

### Technical Solution

One aspect of the present invention provides a method for decoding signals received via two or more paths in a system supporting an Orthogonal Frequency Division Multiplexing (OFDM)/Orthogonal Frequency Division Multiple Access (OFDMA) scheme, the method comprising the steps of: measuring power of a signal received via each path; generating correlation metrics by calculating inner products of basis vector sets or multiplying the basis vector sets in units of tiles or bins of a signal; and generating decoding metrics based on the measured power of each path and the correlation metrics; and determining a payload on the basis of the decoding metrics.

Another aspect of the present invention provides an apparatus for decoding signals received via two or more paths in a system supporting an OFDM/OFDMA scheme, the apparatus comprising: a signal power measuring means for measuring power of a signal received via each path; a demodulation/decoding means for generating correlation metrics corresponding to likelihoods of potential payload values of a signal received via each path; and a maximum ratio combining (MRC)/determination means for determining a payload based on measured power of each path and the sets of metrics.

### ADVANTAGEOUS EFFECTS

Using a plurality of antennas together, the inventive decoding apparatus and method decode signals received through the plurality of antennas, thereby improving receiving quality.

In addition, the present invention can increase the power consumption efficiency of a radio access station (RAS) having a plurality of antennas.

In addition, the present invention reduces a retransmission rate due to reception failure of an RAS, thereby increasing the power consumption efficiency of a portable subscriber station (PSS) connected to the RAS.

### DESCRIPTION OF DRAWINGS

FIG. 1 illustrates the structure of a wireless portable Internet system in which a decoding apparatus of the present invention can be implemented;

FIG. 2 is a timing diagram showing a structure of a data transmission frame of a wireless portable Internet system;

FIG. 3A illustrates a bin structure;

FIG. 3B illustrates an optional partial usage subchannel (OPUSC) tile structure;

FIG. 3C illustrates a partial usage subchannel (PUSC) tile structure;

FIG. 4 is a block diagram showing a part of the constitution of an encoder corresponding to a decoding apparatus of the present invention;

FIG. 5 is a flowchart showing a decoding method according to an exemplary embodiment of the present invention;

FIG. 6 is a conceptual diagram illustrating a maximum ratio combining (MRC) correlation metric generation process of FIG. 5 according to an exemplary embodiment of the present invention;

FIG. 7 is a conceptual diagram illustrating a process of generating correlation metrics of one path shown in FIG. 6 according to an exemplary embodiment of the present invention;

FIG. 8 is a conceptual diagram illustrating a decoding metric generation process of FIG. 5 according to an exemplary embodiment of the present invention;

FIG. 9 is a block diagram showing a constitution of a wireless core module in a receiving-end of a portable Internet radio access station (RAS) in which a decoding apparatus of the present invention can be implemented according to an exemplary embodiment of the present invention; and

FIG. 10 is a block diagram showing constitutions of a demodulation/decoding means and an MRC/determination means of FIG. 9.

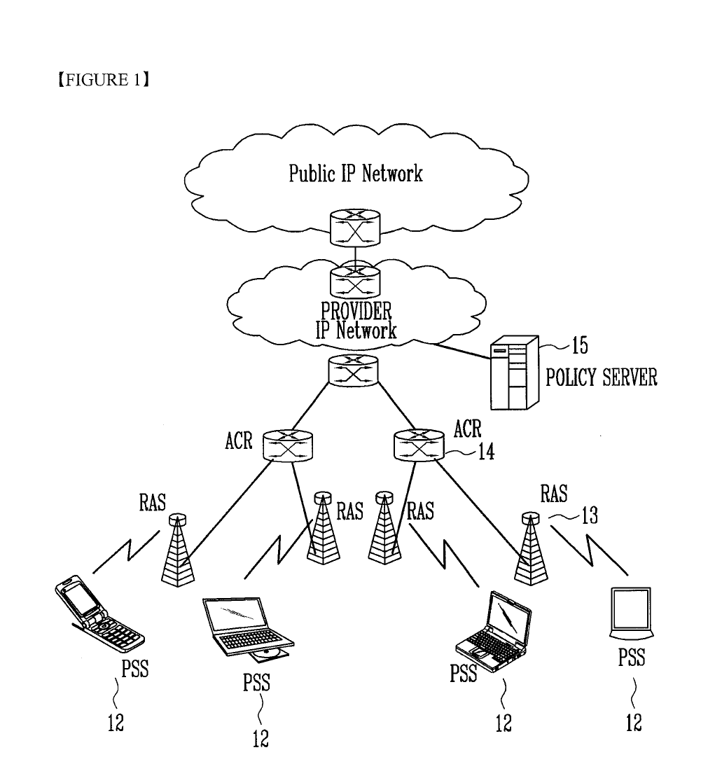

### MODE FOR INVENTION

Hereinafter, exemplary embodiments of the present invention will be described in detail. However, the present invention is not limited to the exemplary embodiments disclosed below, but can be implemented in various forms. The exemplary embodiments are described so that this disclosure will enable those of ordinary skill in the art to which the invention pertains to embody and practice the invention.

For example, the spirit of the present invention can be applied to a decoding apparatus for data demodulation in a receiving end of a communication system having equipment receiving signals of the same frequency through a plurality of antennas. For convenience, the present invention is implemented in a decoding apparatus at a receiving end of a wireless portable Internet system radio access station (RAS) based on an Orthogonal Frequency Division Multiplexing (OFDM)/Orthogonal Frequency Division Multiple Access (OFDMA) scheme in the following embodiments, but the invention is not limited to such implementation.

### Exemplary Embodiments

The present exemplary embodiment is a wireless portable Internet system conforming to the Institute of Electrical and Electronics Engineers (IEEE) 802.16d standard or the IEEE 802.16e standard, to which the spirit of the present invention is applied. In particular, the wireless portable Internet system is implemented for transmission of a fast feedback signal. To be specific, subchannels for fast feedback signal transmission, through which a 6-bit payload is transmitted on 48 subcarriers, are considered in this exemplary embodiment. Each fast feedback subchannel consists of one OFDM/OFDMA subchannel allocated to a portable subscriber station (PSS). Each OFDM/OFDMA subchannel is mapped by a method similar to general uplink data mapping.

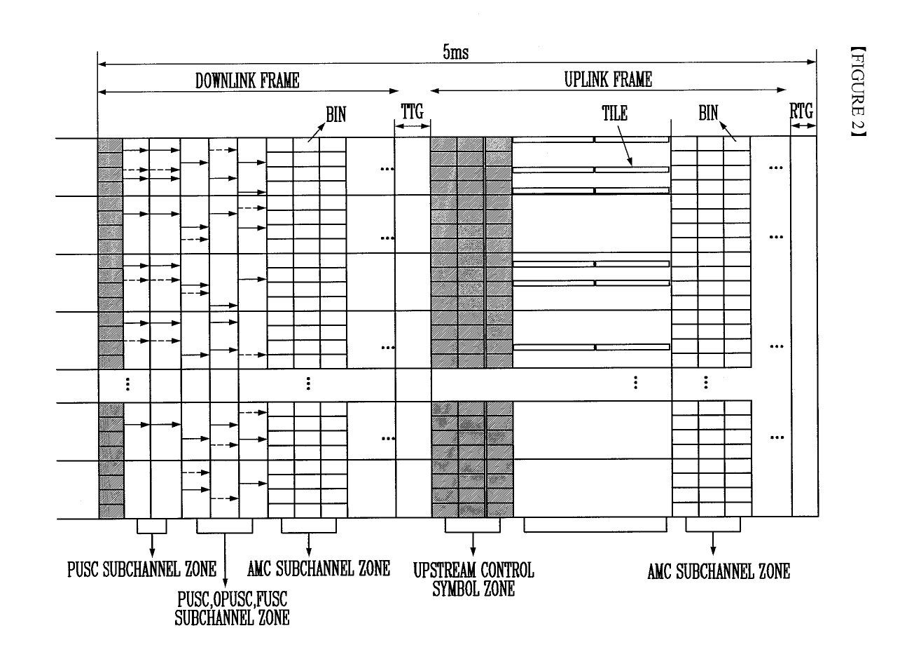

In the wireless portable Internet system employing the OFDM/OFDMA scheme, all transmission frames on a wireless channel, through which data communication is performed between one RAS and a plurality of PSSs, have the structure shown in FIG. 2. The illustrated frame, to which a time division method (TDM) is applied for 5 ms, is divided into an uplink frame containing data to be transmitted from the PSSs to the RAS, and a downlink frame containing data to be transmitted from the RAS to the PSSs.

According to the IEEE 802.16e standard and the IEEE 802.16d standard, a fast feedback signal is transmitted by quadrature phase shift keying (QPSK) modulation signal distributed to 48 subcarriers constituting a subchannel allocated to each PSS (24 subcarriers for an ACK/NACK signal). Among the subchannels, a fast feedback subchannel uses QPSK modulation having 48 subcarriers, and can transfer 6-bit fast feedback data. The 48 subcarriers may be obtained from 6 optional partial usage of subchannel (OPUSC) tiles, 6 partial usage subchannel (PUSC) tiles, or another zone like an adaptive modulation and coding (AMC) zone.

FIG. 2 illustrates a structure of an uplink/downlink frame of a wireless portable Internet system conforming to the standards. The illustrated frame is divided into an uplink frame and a downlink frame. The downlink frame comprises a PUSC subchannel zone, a PUSC, OPUSC, FUSC subchannel zone, and an adaptive modulation and coding (AMC) subchannel zone, and the uplink frame comprises an upstream control symbol zone, a diversity subchannel zone, and an AMC subchannel zone. Each zone is used to transmit data on each PSS or control signals according to its usage.

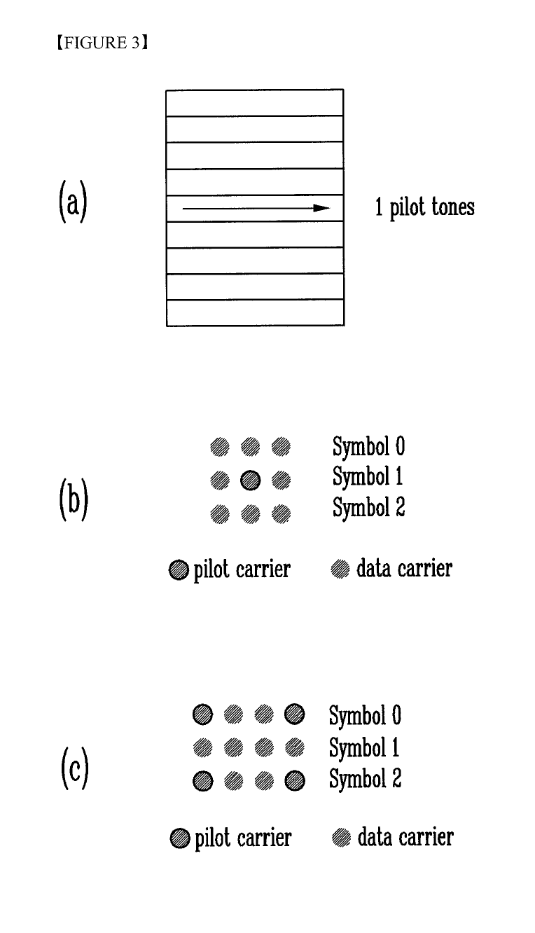

In the frame of FIG. 2, tiles and bins are used as a transmission unit for dividing and transferring data. The tiles and bins consist of subcarriers corresponding to one period capable of carrying one phase signal. A bin is a data transmission unit consisting of subcarriers having 9 sequential frequencies at the same point of time, as illustrated in FIG. 3A, and uses a subcarrier having an intermediate frequency to transmit a pilot signal. The tiles may be OPUSC tiles and/or PUSC tiles. The OPUSC tile consists of 9 subcarriers defined by 3 frequency units and 3 time units, as illustrated in FIG. 3B, and uses one center subcarrier to transmit a pilot signal. The PUSC tile consists of 12 subcarriers defined by 4 frequency units and 3 time units, as illustrated in FIG. 3C, and uses 4 subcarriers at the angular points to transmit a pilot signal.

Among many kinds of signals transmitted to operate the wireless portable Internet, the fast feedback signal and the ACK/NACK signal can be transmitted by a QPSK modulation scheme according to this exemplary embodiment. The signals are payloads having a size of 1 bit, 3 bits, 4 bits, 5 bits or 6 bits according to a kind specified in the IEEE 802.16d standard, the IEEE 802.16e standard, or other standards. In the case of the fast feedback signal, the number of subcarriers of one PSS for carrying the payloads is specified to be 48 in the standards. In addition, in order to ensure 48 subcarriers, it is specified that one subchannel includes 6 tiles. Furthermore, in the case of a 1 bit ACK/NACK signal, the subchannel of one PSS for carrying the payloads is specified to consist of 3 tiles in the standards.

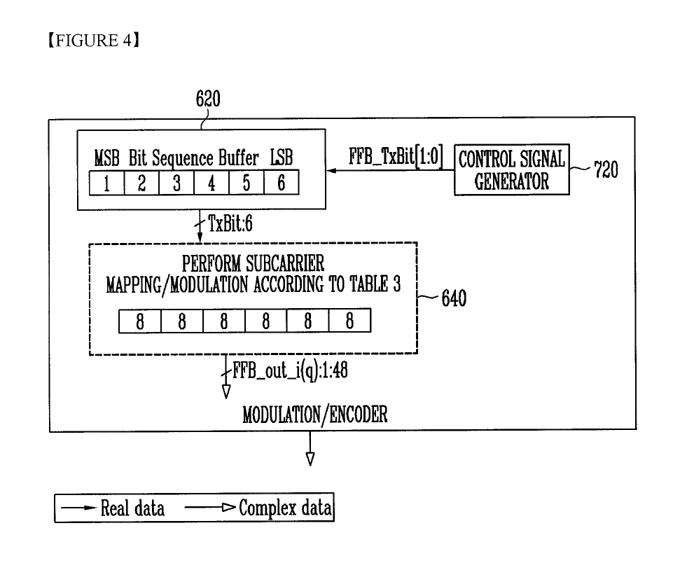

FIG. 4 illustrates the structure of an encoder of a PSS constituting a wireless Internet system. The illustrated encoder comprises an input buffer 620 for receiving 6-bit data to be encoded, and a mapping block 640 for encoding the data latched in the input buffer 620 according to a predetermined algorithm. The 6-bit data is input from a control signal generator 720.

The input 6-bit value is symbol-mapped onto 6 vector indices capable of filling 6 tiles. 6 vector indices corresponding to each input 6-bit value are shown in Table 1 below. The index numbers “0” to “7” representing tile values in Table 1 are denoted by sets of vectors shown in Table 2 below. Each vector is denoted by 4 complex numbers having a phase difference of 90 degrees, as shown in Formulae 1 below, and is physically applied to a subcarrier.

TABLE 1

| 6-bit payload | vector indices |
|---|---|
| 000000 | 0, 0, 0, 0, 0, 0 |
| 000001 | 1, 1, 1, 1, 1, 1 |
| 000010 | 2, 2, 2, 2, 2, 2 |
| 000011 | 3, 3, 3, 3, 3, 3 |
| 000100 | 4, 4, 4, 4, 4, 4 |
| 000101 | 5, 5, 5, 5, 5, 5 |
| 000110 | 6, 6, 6, 6, 6, 6 |
| 000111 | 7, 7, 7, 7, 7, 7 |
| 001000 | 2, 4, 3, 6, 7, 5 |
| 001001 | 3, 5, 2, 7, 6, 4 |
| 001010 | 0, 6, 1, 4, 5, 7 |
| 001011 | 1, 7, 0, 5, 4, 6 |
| 001100 | 6, 0, 7, 2, 3, 1 |
| 001101 | 7, 1, 6, 3, 2, 0 |
| 001110 | 4, 2, 5, 0, 1, 3 |
| 001111 | 5, 3, 4, 1, 0, 2 |
| 010000 | 4, 3, 6, 7, 5, 1 |
| 010001 | 5, 2, 7, 6, 4, 0 |
| 010010 | 6, 1, 4, 5, 7, 3 |
| 010011 | 7, 0, 5, 4, 6, 2 |
| 010100 | 0, 7, 2, 3, 1, 5 |
| 010101 | 1, 6, 3, 2, 0, 4 |
| 010110 | 2, 5, 0, 1, 3, 7 |
| 010111 | 3, 4, 1, 0, 2, 6 |
| 011000 | 3, 6, 7, 5, 1, 2 |
| 011001 | 2, 7, 6, 4, 0, 3 |
| 011010 | 1, 4, 5, 7, 3, 0 |
| 011011 | 0, 5, 4, 6, 2, 1 |
| 011100 | 7, 2, 3, 1, 5, 6 |
| 011101 | 6, 3, 2, 0, 4, 7 |
| 011110 | 5, 0, 1, 3, 7, 4 |
| 011111 | 4, 1, 0, 2, 6, 5 |
| 100000 | 6, 7, 5, 1, 2, 4 |
| 100001 | 7, 6, 4, 0, 3, 5 |
| 100010 | 4, 5, 7, 3, 0, 6 |
| 100011 | 5, 4, 6, 2, 1, 7 |
| 100100 | 2, 3, 1, 5, 6, 0 |
| 100101 | 3, 2, 0, 4, 7, 1 |
| 100110 | 0, 1, 3, 7, 4, 2 |
| 100111 | 1, 0, 2, 6, 5, 3 |
| 101000 | 7, 5, 1, 2, 4, 3 |
| 101001 | 6, 4, 0, 3, 5, 2 |
| 101010 | 5, 7, 3, 0, 6, 1 |
| 101011 | 4, 6, 2, 1, 7, 0 |
| 101100 | 3, 1, 5, 6, 0, 7 |
| 101101 | 2, 0, 4, 7, 1, 6 |
| 101110 | 1, 3, 7, 4, 2, 5 |
| 101111 | 0, 2, 6, 5, 3, 4 |
| 110000 | 5, 1, 2, 4, 3, 6 |
| 110001 | 4, 0, 3, 5, 2, 7 |
| 110010 | 7, 3, 0, 6, 1, 4 |
| 110011 | 6, 2, 1, 7, 0, 5 |
| 110100 | 1, 5, 6, 0, 7, 2 |
| 110101 | 0, 4, 7, 1, 6, 3 |
| 110110 | 3, 7, 4, 2, 5, 0 |
| 110111 | 2, 6, 5, 3, 4, 1 |
| 111000 | 1, 2, 4, 3, 6, 7 |
| 111001 | 0, 3, 5, 2, 7, 6 |
| 111010 | 3, 0, 6, 1, 4, 5 |
| 111011 | 2, 1, 7, 0, 5, 4 |
| 111100 | 5, 6, 0, 7, 2, 3 |
| 111101 | 4, 7, 1, 6, 3, 2 |
| 111110 | 7, 4, 2, 5, 0, 1 |
| 111111 | 6, 5, 3, 4, 1, 0 |

TABLE 2

| Vector index | Subcarrier modulated data |
|---|---|
| 0 | P0, P1, P2, P3, P0, P1, P2, P3 |
| 1 | P0, P3, P2, P1, P0, P3, P2, P1 |
| 2 | P0, P0, P1, P1, P2, P2, P3, P3 |
| 3 | P0, P0, P3, P3, P2, P2, P1, P1 |
| 4 | P0, P0, P0, P0, P0, P0, P0, P0 |
| 5 | P0, P2, P0, P2, P0, P2, P0, P2 |
| 6 | P0, P2, P0, P2, P2, P0, P2, P0 |
| 7 | P0, P2, P2, P0, P2, P0, P0, P2 |

Formulae 1
$P0 = exp ( j \cdot \frac{π}{4} )$
$P1 = exp ( j \cdot \frac{3 π}{4} )$
$P2 = exp ( - j \cdot \frac{3 π}{4} )$
$P3 = exp ( - j \cdot \frac{π}{4} )$

According to Tables 1 and 2, one input 6-bit value is converted into 6 tile values, each tile value consists of a set of 8 vectors, and each vector is carried by one subcarrier. Consequently, one input 6-bit value is carried by 48 subcarriers, i.e., 6* 8=48. Table 3 below shows the relation in further detail.

TABLE 3

| 6-bit | |
|---|---|
| payload | 48 data subcarriers |
| 000000 | 1+i −1+i −1− i 1− i 1+i −1+i −1−i 1− i 1+ i −1+ i −1− i 1− i 1+ i −1+ i −1 − i |
| | 1 − i 1 + i −1 + i −1 − i 1 − i 1 + i −1 + i |
| | −1 − i 1 − i 1 + i −1 + i −1 − i 1 − i 1 + i −1 + i −1 − i 1 − i 1 + i −1 + i −1 − i |
| | 1 − i 1 + i −1 + i −1 − i 1 − i 1 + i −1 + i −1 − i 1 − i 1 + i −1 + i −1 − i 1 − i |
| 000001 | 1 + i 1 − i −1 − i −1 + i 1 + i 1 − i −1 − i −1 + i 1 + i 1 − i −1 − i −1 + i 1 + i 1 − i |
| | −1 − i −1 + i 1 + i 1 − i −1 − i −1 + i 1 + i 1 − i −1 − i −1 + i 1 + i 1 − i −1 − i |
| | −1 + i 1 + i 1 − i −1 − i −1 + i 1 + i 1 − i −1 − i −1 + i 1 + i 1 − i −1 − i −1 + i |
| | 1 + i 1 − i −1 − i −1 + i 1 + i 1 − i −1 − i −1 + i |
| 000010 | 1 + i 1 + i −1 + i −1 + i −1 − i −1 − i 1 − i 1 − i 1 + i 1 + i −1 + i −1 + i −1 − i −1 − i |
| | 1 − i 1 − i 1 + i 1 + i −1 + i −1 + i −1 − i |
| | −1 − i 1 − i 1 − i 1 + i 1 + i −1 + i −1 + i −1 − i −1 − i 1 − i 1 − i 1 + i 1 + i −1 + i |
| | −1 + i −1 − i −1 − i 1 − i 1 − i 1 + i 1 + i |
| | −1 + i −1 + i −1 − i −1 − i 1 − i 1 − i |
| 000011 | 1 + i 1 + i 1 − i 1 − i −1 − i −1 − i −1 + i −1 + i 1 + i 1 + i 1 − i 1 − i −1 − i −1 − i |
| | −1 + i −1 + i 1 + i 1 + i 1 − i 1 − i −1 − i |
| | −1 − i −1 + i −1 + i 1 + i 1 + i 1 − i 1 − i −1 − i −1 − i −1 + i −1 + i 1 + i 1 + i |
| | 1 − i 1 − i −1 − i −1 − i −1 + i −1 + i 1 + i 1 + i 1 − i 1 − i −1 − i −1 − i −1 + i |
| | −1 + i |
| 000100 | 1 + i 1 + i 1 + i 1 + i 1 + i 1 + i 1 + i 1 + i 1 + i 1 + i 1 + i 1 + i 1 + i |
| | 1 + i 1 + i 1 + i 1 + i 1 + i 1 + i 1 + i 1 + i 1 + i 1 + i 1 + i 1 + i |
| | 1 + i 1 + i 1 + i 1 + i 1 + i 1 + i 1 + i 1 + i 1 + i 1 + i 1 + i 1 + i |
| | 1 + i 1 + i 1 + i 1 + i |
| | 1 + i 1 + i 1 + i 1 + i 1 + i 1 + i 1 + i |
| 000101 | 1 + i −1 − i 1 + i −1 − i 1 + i −1 − i 1 + i −1 − i 1 + i −1 − i 1 + i −1 − i 1 + i −1 − i |
| | 1 + i −1 − i 1 + i −1 − i 1 + i −1 − i 1 + i |
| | −1 − i 1 + i −1 − i 1 + i −1 − i 1 + i −1 − i 1 + i −1 − i 1 + i −1 − i 1 + i −1 − i |
| | 1 + i −1 − i 1 + i −1 − i 1 + i −1 − i 1 + i −1 − i |
| | 1 + i −1 − i 1 + i −1 − i 1 + i −1 − i |
| 000110 | 1 + i −1 − i 1 + i −1 − i −1 − i 1 + i −1 − i 1 + i 1 + i −1 − i 1 + i −1 − i −1 − i |
| | 1 + i −1 − i 1 + i 1 + i −1 − i 1 + i −1 − i −1 − i 1 + i −1 − i 1 + i 1 + i −1 − i |
| | 1 + i −1 − i −1 − i 1 + i −1 − i 1 + i 1 + i −1 − i 1 + i −1 − i −1 − i 1 + i −1 − i |
| | 1 + i 1 + i −1 − i |
| | 1 + i −1 − i −1 − i 1 + i −1 − i 1 + i |
| 000111 | 1 + i −1 − i −1 − i 1 + i −1 − i 1 + i 1 + i −1 − i 1 + i −1 − i −1 − i 1 + i −1 − i |
| | 1 + i 1 + i −1 − i 1 + i −1 − i −1 − i 1 + i −1 − i 1 + i 1 + i −1 − i 1 + i −1 − i |
| | −1 − i 1 + i −1 − i 1 + i 1 + i −1 − i 1 + i −1 − i −1 − i 1 + i −1 − i 1 + i 1 + i |
| | −1 − i 1 + i −1 − i |
| | −1 − i 1 + i −1 − i 1 + i 1 + i −1 − i |
| . . . | . . . . . . |
| 111110 | 1 + i −1 − i −1 − i 1 + i −1 − i 1 + i 1 + i −1 − i 1 + i 1 + i 1 + i 1 + i 1 + i |
| | 1 + i 1 + i 1 + i 1 + i 1 + i −1 + i −1 + i |
| | −1 − i −1 − i 1 − i 1 − i 1 + i −1 − i 1 + i −1 − i 1 + i −1 − i 1 + i −1 − i 1 + i −1 + i |
| | −1 − i 1 − i 1 + i −1 + i −1 − i 1 − i |
| | 1 + i 1 − i −1 − i −1 + i 1 + i 1 − i −1 − i −1 + i |
| 111111 | 1 + i −1 − i 1 + i −1 − i −1 − i 1 + i −1 − i 1 + i 1 + i −1 − i 1 + i −1 − i 1 + i −1 − i |
| | 1 + i −1 − i 1 + i 1 + i 1 − i 1 − i |
| | −1 − i −1 − i −1 + i −1 + i 1 + i 1 + i 1 + i 1 + i 1 + i 1 + i 1 + i 1 + i 1 + i |
| | 1 − i −1 − i −1 + i 1 + i 1 − i −1 − i −1 + i |
| | 1 + i −1 + i −1 − i 1 − i 1 + i −1 + i −1 − i 1 − i |

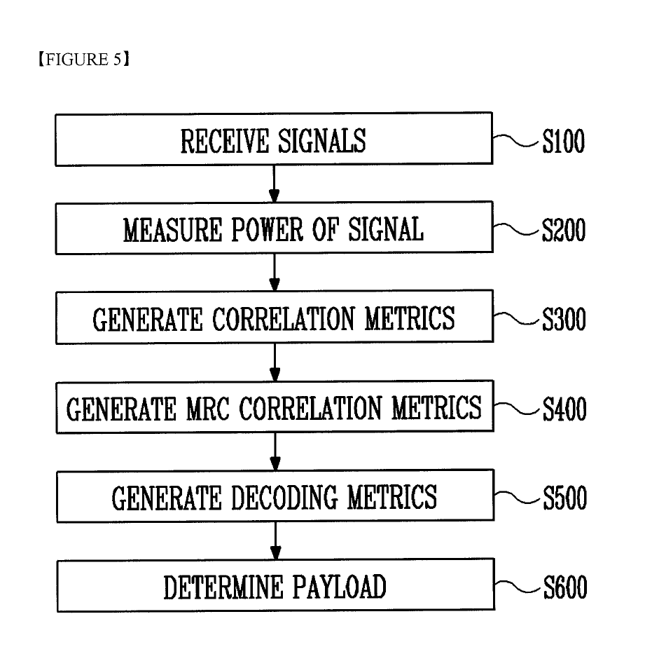

FIG. 5 illustrates a decoding method in a system supporting an OFDM/OFMDA scheme according to an exemplary embodiment of the present invention. The illustrated decoding method comprising the steps of: receiving signals via two or more paths (step 100); measuring powers of the signals received via the respective paths (step 200); calculating inner products of basis vector sets or multiplying the basis vector sets in units of tiles or bins of the signals received via the respective paths, and generating sets of correlation metrics (step 300); generating decoding metrics based on the measured powers of the respective paths and the correlation metrics (steps 400 and 500); and determining a payload on the basis of the decoding metrics (step 600).

Here, the step of generating decoding metrics from the sets of correlation metrics comprises the sub-steps of: giving a weight depending on the power of a signal corresponding to each path to correlation metrics of the path, summing up correlation metrics to which the weights are given, and generating maximum ratio combining (MRC) correlation metrics (step 400); and generating decoding metrics corresponding to likelihoods based on the MRC correlation metrics and potential payload values (step 500).

When the decoding method of the present invention is applied to a wireless portable Internet system conforming to the IEEE 802.16d or the IEEE 802.16e standard, in the step of measuring power of the signal (step 200), power measurement may be performed in units of a burst, a subchannel, or a slot allocated to one PSS, or in units of tiles or bins constituting the subchannel. In the former case, power measurement may be performed on a predetermined number (e.g., 48) of all data signals constituting the subchannel, or on an arbitrary or designated small number of data signals only. When power measurement is performed on two or more data signals, the average of the measured power values is determined as the power value of the corresponding subchannel or slot. Here, the average value may be the arithmetic mean value or the geometric mean value.

In the latter case of measuring powers in units of tiles or bins, power measurement may be performed on a pilot signal included in each tile or bin, on data signals, or on a pilot signal and data signals included in each tile or bin. When power measurement is performed on two or more data signals and/or pilot signals, the average of the measured power values is determined as the power value of the corresponding subchannel or slot. Here, the average value may be the arithmetic or geometric mean value.

Before or after the step of receiving signals (step 100), channel estimation and compensation of the received signals may be performed using pilot signals. Here, the estimation of a wireless channel is performed not on an entire uplink section through which one RAS receives signals, but on each subchannel established between one RAS and one PSS. Therefore, the channel estimation is performed by applying not an upstream control symbol zone signal, but pilot signals included in respective tiles of a subchannel zone used for communication with a specific PSS.

The pilot signal has a previously specified amplitude and a phase of 0. In step 200, the amplitude and phase of an actually received pilot signal is compared with the previously specified amplitude and phase of the pilot signal to recognize the differences. A difference in amplitude denotes the amount of attenuation of the received signal, and a difference in phase denotes the amount of delay of the received signal. When the differences are applied to a received signal sharing a wireless channel with the pilot signal, a reference value determining the amplitude of the received signal may be adjusted according to the amount of attenuation, and a point of time at which the received signal is recognized may be adjusted according to the amount of delay. Here, according to the wireless portable Internet standards, 6 tiles are allocated to a subchannel of a PSS for the sake of signal transmission. Thus, the power of a signal carried by 48 subcarriers constituting the 6 tiles is measured after the signal is compensated based on an estimation result of the corresponding tile, and is buffered in a receiving buffer (comprising 6 tile buffers).

When the channel estimation/compensation is performed, it is preferable for simplification of a structure to use pilot signals to measure the power of the signal.

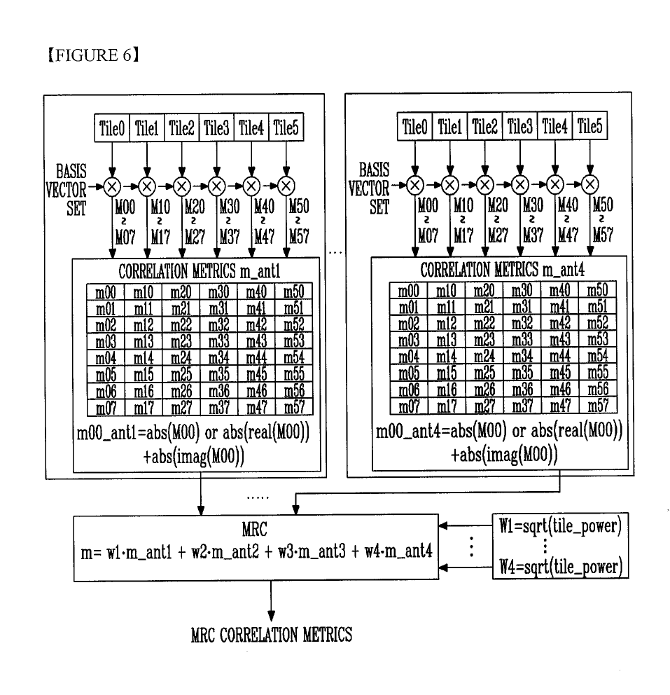

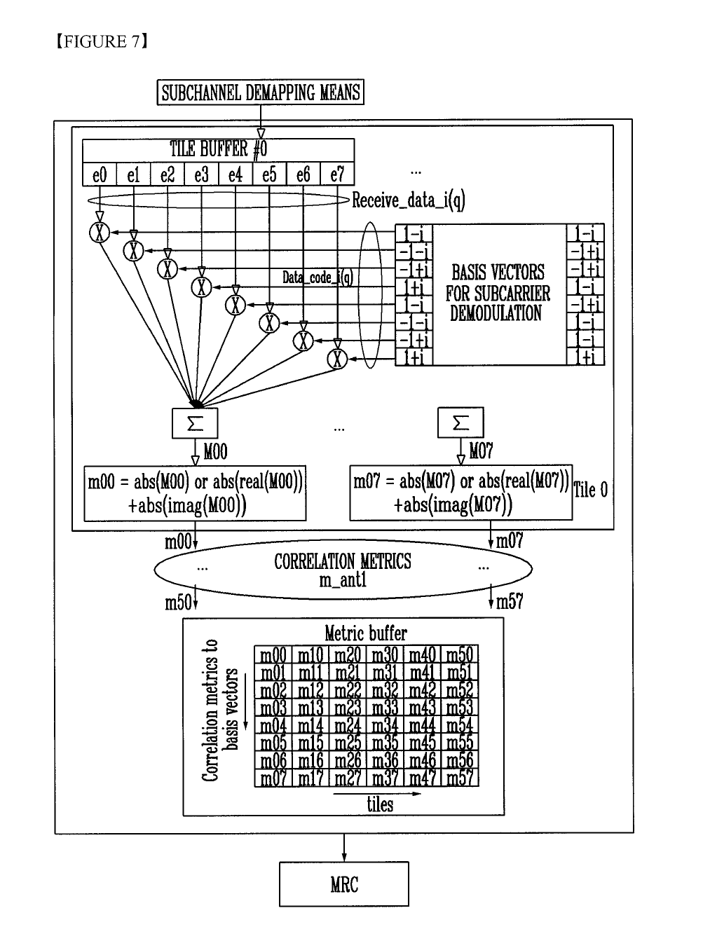

FIG. 6 illustrates a process of generating correlation metrics in step 300 and a process of generating MRC correlation metrics in step 400. Since the illustrated process is for decoding signals received through 4 antennas, correlation metrics (m_ant1 to m_ant4) are generated for respective antenna paths, and measured power values W1 to W4 of the respective antenna paths are obtained. First, the process of generating correlation metrics of each path will be described with reference to FIG. 7.

Here, when the decoding process of this exemplary embodiment is conventionally performed according to wireless portable Internet standards, a decoding table for 3072 subcarriers (64*48=3072) is necessary, which is a heavy burden on a processing device performing decoding as well as a memory storing the table. According to the wireless portable Internet standards, it is specified that 8 phase signals are transmitted by each of 6 tiles, the 48 phase signals are classified into 6 subsets consisting of 8 phase signals, each subset denotes one vector index value, and a combination of a predetermined number of vector index values denotes one payload.

Therefore, this exemplary embodiment performs demodulation with a simple structure using the tile division structure according to the wireless portable Internet standards and an algorithm for generating predetermined vector indices. To this end, a correlation metric denotes likelihood between a signal received in one tile and each vector index of Table 2 and the correlation metric is obtained as data generated in the middle of the decoding process. Here, one set of correlation metrics is generated from 6 tiles and 8 vector indices.

In step 300, correlation metrics may be obtained by calculation based on a received signal and basis vector signals. The calculation can be performed by various well-known methods, depending on the purpose. According to a coherent method, there is no phase difference between two vectors whose inner product will be calculated, and thus the method can be implemented by a simpler inner-product circuit. On the other hand, a non-coherent method performing a multiplying operation on two vectors requires a more complex circuit outputting an imaginary part value as a calculation result. According to an inner product calculation or multiplying method, inner products of 4 signals indicating a subcarrier angle of 90 degrees and a received signal are calculated, or the 4 signals are multiplied by the received signal, and the 4 calculation results are combined into subcarrier demodulation basis vector patterns, thereby obtaining a calculation result based on 8 basis vectors.

There are 3 methods of recording the calculation result having an imaginary part as a correlation metric. One of the 3 methods records the real value of the calculation result alone, another method records the absolute value of the calculation result alone, and the other method records the sum of the real value and the imaginary value of the calculation result.

Received signals, each of which has one of 4 values of Formulae 1 and are carried by 48 subcarriers, are referred to as received signal Nos. 0 to 47 in order of the corresponding subcarriers. According to the standards, the 48 received signals are carried by 6 tiles specified as tiles #0 to #5, that is, 8 signals per tile. For convenient description of processes for generating and using the metrics, correlation metrics are arranged in the form of a 6*8 matrix in the drawings.

In step 300, as illustrated in FIG. 7, inner products of a value buffered in tile buffer #0 and the basis vector signals are calculated, or the value is multiplied by the basis vector signals, and then the result values are summed up to generate a correlation metric. Since the correlation metric generation process is performed once per combination of a value recorded in tile buffer #0 and 8 basis vector signals having the patterns of Table 2 above, a total of 8 correlation metrics are generated as the result of the process. The 8 result values m00 to m07 constitute a first column of correlation metrics.

In the same way, 8 result values m10 to m17 obtained by demodulating a value recorded in tile buffer #1 constitute a second column of the correlation metrics.

This process is repeated until tile buffer #5 is processed, and 8 result values m50 to m57 obtained by demodulating a value recorded in last tile buffer #5 are stored in positions of a sixth column of the correlation metrics.

Each metric constituting the correlation metrics generated as described above denotes a probability of a vector index being an order of a row in each tile denoted by an order of a column. For example, m02 among the correlation metrics of FIG. 7 denotes an index-likelihood corresponding to a probability of a signal carried by tile No. 0 indicating vector No. 2, and m25 denotes an index-likelihood corresponding to a probability of a signal carried by tile No. 2 indicating vector No. 5.

In step 400, as illustrated in FIG. 6, 4 sets of correlation metrics each are multiplied by the power value of the corresponding path, weights are given to them, and then the result values are summed up, thereby generating an MRC correlation metrics. When powers are measured in units of subchannels or slots, the same weight is given to all the components of the correlation metrics. On the other hand, when powers are measured in units of tiles or bins, the same weight is given to the components of each column of the illustrated correlation metrics.

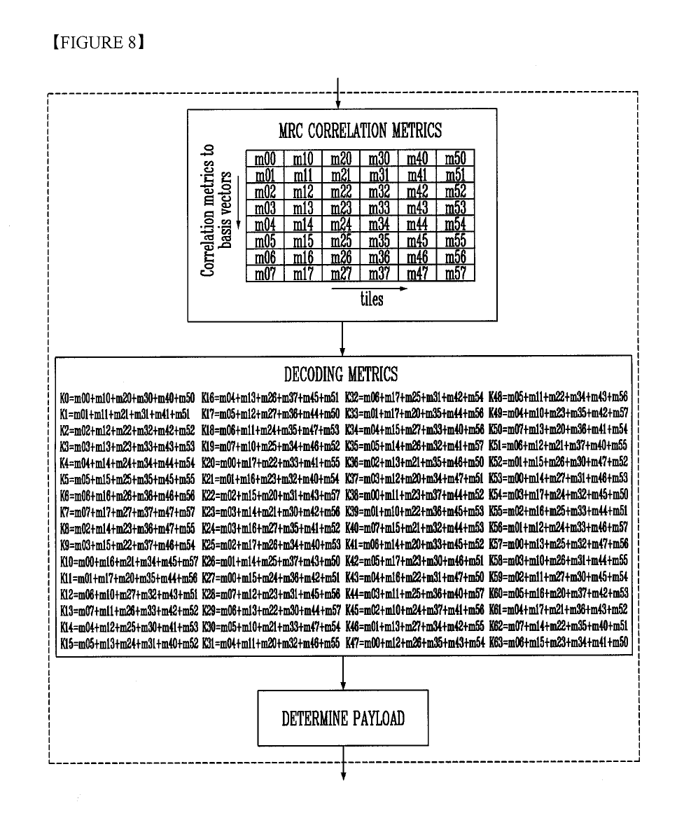

In step 500, as illustrated in FIG. 8, the step of distinguishing a subset used to generate a decoding metric on the basis of the MRC correlation metrics and a specific potential payload value from the components of the correlation metrics, and the step of summing up values of the distinguished subset and calculating a decoding metric for the potential payload value, are repeated for all potential payload values, thereby generating decoding metrics.

In step 500, a payload-likelihood of the final decoding value being a specific payload is calculated using values recorded as the MRC correlation metrics. The calculated payload-likelihood is recorded as a decoding metric, and decoding metrics illustrated in FIG. 8 may be generated by calculating payload-likelihoods of respective potential payload values Nos. 0 to 63 based on received signals of 6 tiles. During the process of generating the decoding metrics, a payload table showing the relation of Table 1 may be used.

The payload table, in which vector indices for the respective potential payload values are recorded, may be implemented by recording vector indices in the case of a payload being 0 in a first row, vector indices in the case of a payload being 1 in a second row, and so on. Therefore, the payload table has 64 rows when a 6-bit payload is carried, and 16 rows when a 4-bit payload is carried. Table 4 below is an exemplary embodiment of a payload table for a 6-bit payload.

TABLE 4

| | | | | | |
|---|---|---|---|---|---|
| 0 | 0 | 0 | 0 | 0 | 0 |
| 1 | 1 | 1 | 1 | 1 | 1 |
| 2 | 2 | 2 | 2 | 2 | 2 |
| 3 | 3 | 3 | 3 | 3 | 3 |
| 4 | 4 | 4 | 4 | 4 | 4 |
| 5 | 5 | 5 | 5 | 5 | 5 |
| 6 | 6 | 6 | 6 | 6 | 6 |
| 7 | 7 | 7 | 7 | 7 | 7 |
| 2 | 4 | 3 | 6 | 7 | 5 |
| 3 | 5 | 2 | 7 | 6 | 4 |
| 0 | 6 | 1 | 4 | 5 | 7 |
| 1 | 7 | 0 | 5 | 4 | 6 |
| 6 | 0 | 7 | 2 | 3 | 1 |
| 7 | 1 | 6 | 3 | 2 | 0 |
| 4 | 2 | 5 | 0 | 1 | 3 |
| 5 | 3 | 4 | 1 | 0 | 2 |
| 4 | 3 | 6 | 7 | 5 | 1 |
| 5 | 2 | 7 | 6 | 4 | 0 |
| 6 | 1 | 4 | 5 | 7 | 3 |
| 7 | 0 | 5 | 4 | 6 | 2 |
| 0 | 7 | 2 | 3 | 1 | 5 |
| 1 | 6 | 3 | 2 | 0 | 4 |
| 2 | 5 | 0 | 1 | 3 | 7 |
| 3 | 4 | 1 | 0 | 2 | 6 |
| 3 | 6 | 7 | 5 | 1 | 2 |
| 2 | 7 | 6 | 4 | 0 | 3 |
| 1 | 4 | 5 | 7 | 3 | 0 |
| 0 | 5 | 4 | 6 | 2 | 1 |
| 7 | 2 | 3 | 1 | 5 | 6 |
| 6 | 3 | 2 | 0 | 4 | 7 |
| 5 | 0 | 1 | 3 | 7 | 4 |
| 4 | 1 | 0 | 2 | 6 | 5 |
| 6 | 7 | 5 | 1 | 2 | 4 |
| 7 | 6 | 4 | 0 | 3 | 5 |
| 4 | 5 | 7 | 3 | 0 | 6 |
| 5 | 4 | 6 | 2 | 1 | 7 |
| 2 | 3 | 1 | 5 | 6 | 0 |
| 3 | 2 | 0 | 4 | 7 | 1 |
| 0 | 1 | 3 | 7 | 4 | 2 |
| 1 | 0 | 2 | 6 | 5 | 3 |
| 7 | 5 | 1 | 2 | 4 | 3 |
| 6 | 4 | 0 | 3 | 5 | 2 |
| 5 | 7 | 3 | 0 | 6 | 1 |
| 4 | 6 | 2 | 1 | 7 | 0 |
| 3 | 1 | 5 | 6 | 0 | 7 |
| 2 | 0 | 4 | 7 | 1 | 6 |
| 1 | 3 | 7 | 4 | 2 | 5 |
| 0 | 2 | 6 | 5 | 3 | 4 |
| 5 | 1 | 2 | 4 | 3 | 6 |
| 4 | 0 | 3 | 5 | 2 | 7 |
| 7 | 3 | 0 | 6 | 1 | 4 |
| 6 | 2 | 1 | 7 | 0 | 5 |
| 1 | 5 | 6 | 0 | 7 | 2 |
| 0 | 4 | 7 | 1 | 6 | 3 |
| 3 | 7 | 4 | 2 | 5 | 0 |
| 2 | 6 | 5 | 3 | 4 | 1 |
| 1 | 2 | 4 | 3 | 6 | 7 |
| 0 | 3 | 5 | 2 | 7 | 6 |
| 3 | 0 | 6 | 1 | 4 | 5 |
| 2 | 1 | 7 | 0 | 5 | 4 |
| 5 | 6 | 0 | 7 | 2 | 3 |
| 4 | 7 | 1 | 6 | 3 | 2 |
| 7 | 4 | 2 | 5 | 0 | 1 |
| 6 | 5 | 3 | 4 | 1 | 0 |

In the case of Table 4, as illustrated in FIG. 8, a decoding metric generator calculates a payload-likelihood of a value recorded in the MRC correlation metrics being 0, a payload-likelihood of a value recorded in the MRC correlation metrics being 1, . . . , and a payload-likelihood of a value recorded in the MRC correlation metrics being 63, thereby generating decoding metrics.

The process of generating the decoding metrics will be described in detail now. Unit values constituting one row of the payload table of Table 4 are read, and components in row orders corresponding to the respective unit values among components in column orders corresponding to the same column orders of the respective unit values, of MRC correlation metrics of Table 5 below, are selected. When a total of 6 components are selected from the correlation metrics, they are summed up to calculate a payload-likelihood of a payload value denoted by the read row. For example, when a first row of the payload table is applied, the component values corresponding to m00, m10, m20, m30, m40 and m50 among the components of the MRC correlation metrics of Table 5 are summed up, and when a ninth row of the payload table is applied, values corresponding to m02, m14, m23, m36, m47 and m55 are summed up.

TABLE 5

| | | | | | |
|---|---|---|---|---|---|
| M00 | m10 | m20 | m30 | m40 | m50 |
| M01 | m11 | m21 | m31 | m41 | m51 |
| M02 | m12 | m22 | m32 | m42 | m52 |
| M03 | m13 | m23 | m33 | m43 | m53 |
| M04 | m14 | m24 | m34 | m44 | m54 |
| m05 | m15 | m25 | m35 | m45 | m55 |
| m06 | m16 | m26 | m36 | m46 | m56 |
| m07 | m17 | m27 | m37 | m47 | m57 |

When the decoding metrics corresponding to likelihoods based on the correlation metrics and respective potential payload values, which may be referred to as potential decoding values because they are potential values of a final decoding result, are generated in step 500, the maximum metric is retrieved from the decoding metrics, and a potential payload value having the maximum decoding metric is determined as a payload in step 600. In step 600, in addition to simply retrieving the maximum metric, a more complex determination algorithm may be used, which uses the secondary maximum metric having the second largest value and/or an average metric, i.e., the average value (arithmetic mean value or geometric mean value) of the decoding metrics. Applicable algorithms using the secondary maximum metric and/or the average metric are expressed in a programming language as shown in Formulas 2 to 9 below according to exemplary embodiments of the present invention.

Formula 2

Decision

```
Find Max(K) and Second(K)
if Max(K)>Threshold
            Make decision
elseif (Max(K)−Second(K))>Threshold_second
                Make Decision
else
                Payload = Payload_PreviousFrame
end
Formula 3
```

Decision

```
Find Max(K) and Second(K)
if Max(K)>Threshold
    Make decision
elseif (Max(K)/Second(K))>Threshold_second
    Make Decision
else
    Payload = Payload_PreviousFrame
end
Formula 4
```

Decision

```
Find Max(K), get the payload and second_payload
if (Max(K)−second(K))>Threshold
      Make decision
elseif (payload ~= payload_PreviousFrame & second_payload ==
Payload_previousFrame)
      Payload = Payload_PreviousFrame
Else
      Payload = Payload_CurrentFrame
end
Formula 5
```

Decision

```
Find Max(K), get the payload and second_payload
if (Max(K)/second(K))>Threshold
      Make decision
elseif (payload ~= payload_PreviousFrame & second_payload ==
Payload_previousFrame)
      Payload = Payload_PreviousFrame
Else
      Payload = Payload_CurrentFrame
end
Formula 6
```

Decision

```
Find Max(K) and compute the average of the Max(K)
if Max(K)>Threshold
    Make decision
elseif (Max(K)−avg_Max(K))>Threshold_second
    Make Decision
else
    Payload = Payload_PreviousFrame
end
Formula 7
```

Decision

```
Find Max(K) and compute the average of the Max(K)
if Max(K)>Threshold
    Make decision
elseif (Max(K)/avg_Max(K))>Threshold_second
    Make Decision
else
    Payload = Payload_PreviousFrame
end
Formula 8
```

Decision

```
Find Max(K), get the payload and second_payload and compute
Avg_max(K)
if (Max(K)−Avg_max(K))>Threshold
      Make decision
elseif (payload ~= payload_PreviousFrame & second_payload ==
Payload_previousFrame)
      Payload = Payload_PreviousFrame
Else
      Payload = Payload_CurrentFrame
end
Formula 9
```

Decision

```
Find Max(K), get the payload and second_payload and compute
Avg_max(K)
if (Max(K)/Avg_max(K))>Threshold
    Make decision
elseif (payload ~= payload_PreviousFrame & second_payload ==
Payload_previousFrame)
    Payload = Payload_PreviousFrame
Else
    Payload = Payload_CurrentFrame
end
```

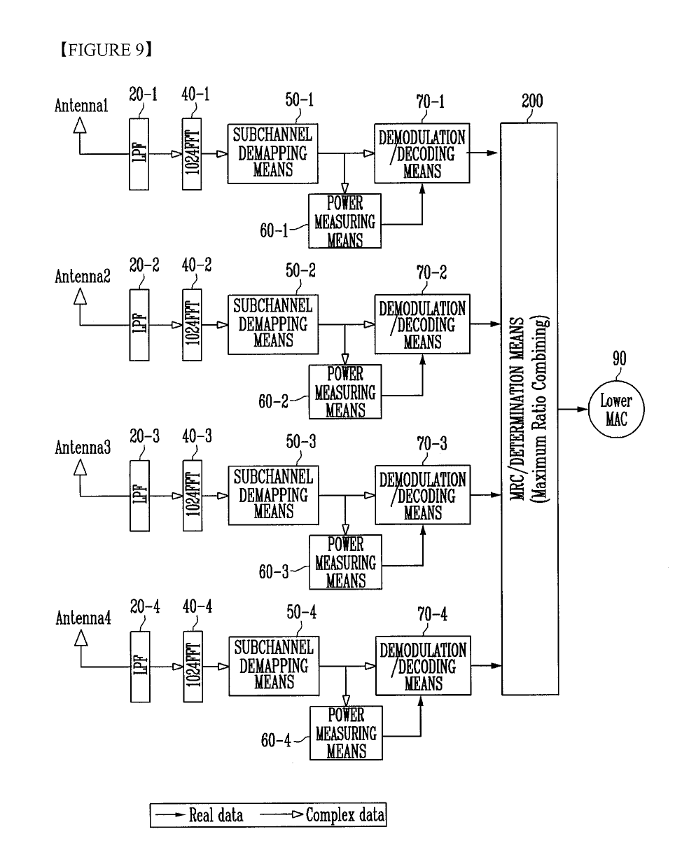

FIG. 9 illustrates a partial constitution of a wireless core module, which includes a decoding apparatus of the present invention, of an RAS's receiving means before a lower media access control (MAC) layer in a portable Internet system. The portable Internet system uses a time division duplexing (TDD) scheme dividing a downlink time and an uplink time, and uses the OFDMA scheme for multiple access. A wireless signal based on the OFDM/OFMDA scheme is received by each receiver antenna while being carried by a plurality of subcarriers, passed through low pass filters 20, converted by fast Fourier transform (FFT) blocks 40 into a plurality of quadrature phase shift keying (QPSK) modulation signals, and input into subchannel demapping means 50. The subchannel demapping means 50 each demap the input phase signals into signals of the corresponding subchannel. The demapped signals are input into power measuring means 60 and demodulation/decoding means 70. The demodulation/decoding means 70 generate correlation metrics from the received signals of the corresponding subchannel, and the power measuring means 60 measure powers of the received signals.

4 sets of correlation metrics and 4 power values obtained from respective antenna paths are input into an MRC/determination means 200. The MRC/determination means 200 gives weights, each weight depending on the 4 power values, to the corresponding sets of correlation metrics to generate MRC correlation metrics, decodes the MRC correlation metrics, and determines a payload. The determined payload is finally input into a MAC layer 90.

When enumeration is performed by a subchannel mapping means (not shown in the drawings) in some embodiments, a de-enumeration means may be further included between the demodulation/decoding means 70 and the MAC layer 90. Besides the de-enumeration means, other components associated with communication data conversion, such as a rotation unit, a permutation unit, etc., may be further included. Needless to say, however, the scope of the present invention is not limited by whether such components are added or not.

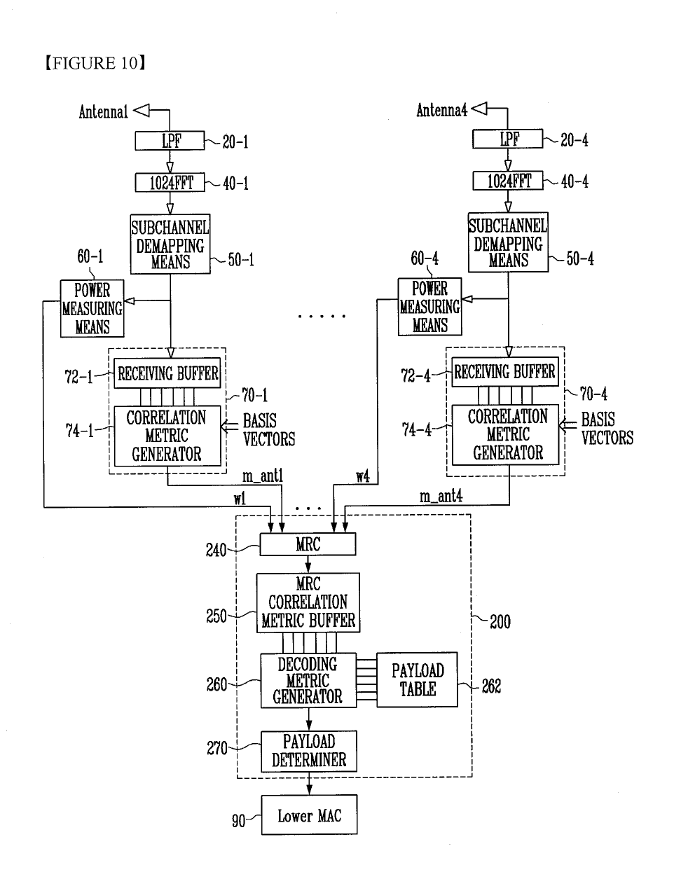

FIG. 10 illustrates constitutions of the demodulation/decoding means 70 and the MRC/determination means 200 of this exemplary embodiment. The demodulation/decoding means 70 estimates a payload carried by a plurality of received signals distributed to 6 tiles or bins through each antenna path. As illustrated in FIG. 10, the demodulation/decoding means 70 each comprises a receiving buffer 72 and a correlation metric generator 74. The receiving buffer 72 buffers input QPSK modulated signals. The correlation metric generator 74 generates correlation metrics by multiplying or calculating inner products of 8 basis vector sets in units of tiles or bins of a signal received via each path.

The receiving buffer 72 may include a plurality of tile buffers for buffering received signals according to respective tiles constituting a subchannel. In an exemplary embodiment conforming to the portable Internet standards, the receiving buffer 72 may include 6 tile buffers distinguished as tile buffers #0 to #5. Received signal Nos. 0 to 7 among the 48 received signals distinguished by Nos. 0 to 47 are stored in the tile buffer #0, i.e., a buffer for tile 0. Received signal Nos. 8 to 15 are stored in a buffer for tile 1, and received signal Nos. 16 to 23 are stored in a buffer for tile 2. The process is repeated in the same way, and received signal Nos. 40 to 47 are stored in a final buffer for tile 6.

A basis vector generator (not shown in the drawings) for generating basis vector signal sets required for demodulation may be further included. The basis vector generator may include a demodulation table storing patterns of 8 basis vectors. In addition, the basis vector generator reads pattern information of the basis vectors and generates basis vector signals required for performing demodulation. Here, the basis vectors denote values of 0 to 7, respectively. In Table 5, a result value obtained by applying a first column of the demodulation table is m00, and a result value obtained by applying an eighth, i.e., the last, column is m07. It is preferable to have only one basis vector generator to use the basis vector signals for demodulation of the 4 paths as well as 6 tiles included in one path.

The MRC/determination means 200 comprises an MRC 240, a decoding metric generator 260, and a payload determiner 270. The MRC 240 gives a weight depending on a measured power value of each path to each set of correlation metrics derived from the corresponding path and combines the results, thereby generating MRC correlation metrics. The decoding metric generator 260 generates decoding metrics corresponding to likelihoods based on the MRC correlation metrics and potential payload values. The payload determiner 270 determines a payload on the basis of the decoding metrics. In some embodiments, an MRC correlation metric buffer 250 for storing the MRC correlation metrics and/or a payload table 262 having the structure of Table 4 above required for decoding metric generation may be further included.

The payload determiner 270 may determine a potential payload value having the maximum metric as a payload, or determine a payload according to a somewhat complex algorithm as shown in Formulas 2 to 9.

While the invention has been shown and described with reference to certain exemplary embodiments thereof, it will be understood by those skilled in the art that various changes in form and details may be made therein without departing from the spirit and scope of the invention as defined by the appended claims.

1. A method for decoding signals received via at least two paths through a plurality of antennas in a system supporting an Orthogonal Frequency Division Multiplexing (OFDM)/Orthogonal Frequency Division Multiple Access (OFDMA) scheme, the method comprising the steps of:
measuring power of a signal received via each path;
generating correlation metrics by calculating inner products of basis vector sets or multiplying the basis vector sets in units of tiles or bins of the signal;
generating decoding metrics based on the measured power of each path and the correlation metrics; and
determining a payload on the basis of the decoding metrics.

2. The method of claim 1, wherein the step of determining a payload comprises the steps of:
giving weights depending on the signal power of each path to correlation metrics of each path;
summing up the correlation metrics to which the weights are given and generating maximum ratio combining (MRC) correlation metrics; and
generating decoding metrics corresponding to likelihoods based on the MRC correlation metrics and potential payload values.

3. The method of claim 1, wherein a potential payload value corresponding to a decoding metric having a largest value among the decoding metrics is determined as the payload.

4. The method of claim 1, wherein the step of measuring power of a signal comprises the steps of:
(a) performing power measurement in each tile or bin; and
(b) averaging result values of the power measurement.

5. The method of claim 4, wherein step (a) is performed by measuring power of a pilot signal included in each tile or bin.

6. The method of claim 4, wherein step (a) is performed by measuring power of a data signal included in each tile or bin.

7. The method of claim 1, wherein the step of measuring power of a signal comprises the steps of:
selecting at least two received signals from signals received via each path; and
averaging measured power values of the selected signals.

8. An apparatus for decoding signals received via at least two paths through a plurality of antennas in a system supporting an Orthogonal Frequency Division Multiplexing (OFDM)/Orthogonal Frequency Division Multiple Access (OFDMA) scheme, the apparatus comprising:
a signal power measuring means for measuring power of a signal received via each path;
a demodulation/decoding means for generating correlation metrics corresponding to likelihoods of potential payload values of a signal received via each path; and
a maximum ratio combining (MRC)/determination means for determining a payload based on the measured power of each path and the correlation metrics.

9. The apparatus of claim 8, wherein the demodulation/decoding unit comprises:
a receiving buffer for buffering quadrature phase shift keying (QPSK) modulated signal received via each path; and
a correlation metric generator for multiplying or calculating inner products of 8 basis vector sets by tiles or bins of a signal received via each path and generating correlation metrics.

10. The apparatus of claim 9, wherein the MRC/determination means comprises:
an MRC for giving weights depending on the measured power value of signal of each path to sets of correlation metrics derived from the corresponding path, combining the sets of correlation metrics, and generating MRC correlation metrics;
a decoding metric generator for generating decoding metrics corresponding to likelihoods based on the MRC correlation metrics and potential payload values; and
a payload determiner for determining a payload on the basis of the decoding metrics.

11. The apparatus of claim 10, wherein the payload determiner determines a potential payload value corresponding to a decoding metric having a largest value among the decoding metrics as the payload.

12. The apparatus of claim 9, wherein the signal power measuring means performs power measurement in the units of tiles or bins.

13. The apparatus of claim 9, wherein the signal power measuring means performs power measurement by measuring powers of at least two data signals received via each path and averaging the measured power values.

14. The apparatus of claim 8, further comprising:
a wireless channel estimator/compensator for compensating the received signal according to a channel estimation result obtained using pilot signal.

15. The apparatus of claim 8, further comprising:
a correlation metric buffer for storing the sets of correlation metrics.

16. The apparatus of claim 8, further comprising:
a basis vector generator for generating basis vectors required to calculate the sets of correlation metrics based on the received signals.

17. The apparatus of claim 8, wherein the received signal comprises a feedback message or an acknowledgment message.

18. A decoding method in a receiving apparatus having at least two antennas and supporting an Orthogonal Frequency Division Multiplexing (OFDM)/Orthogonal Frequency Division Multiple Access (OFDMA) scheme, the decoding method comprising the steps of:
performing subcarrier demodulation on each signal of receiving channel to generate correlation metrics of the receiving channel using subcarrier modulation basis vector sets in units of tiles or bins;
calculating decoding metrics on the basis of weights and the correlation metrics of the receiving channels; and
determining a payload on the basis of the decoding metrics.

19. The decoding method of claim 18, wherein each of the weights of the receiving channel is determined according to a measured power value of a pilot signal or data signals of a corresponding channel.

20. The decoding method of claim 18, wherein the signal of the receiving channel is quadrature phase shift keying (QPSK) subcarrier modulated signal.
